(19) United States
(12) Patent Application Publication
(10) Pub. No.: US 2015/0070588 A1
(43) Pub. Date: Mar. 12, 2015

(54) IMAGING PROCESSING CIRCUIT FOR GENERATING AND STORING UPDATED PIXEL SIGNAL IN STORAGE CAPACITOR BEFORE NEXT OPERATING CYCLE

(71) Applicant: Himax Imaging, Inc., Grand Cayman (KY)

(72) Inventor: Ping-Hung Yin, Grand Cayman (KY)

(73) Assignee: Himax Imaging, Inc., Grand Cayman (KY)

(21) Appl. No.: 14/025,816

(22) Filed: Sep. 12, 2013

(51) Int. Cl. H04N 1/38

(52) U.S. Cl. CPC H04N 1/38
USPC 348/607

(57) ABSTRACT

An imaging processing circuit includes at least a pixel sensor and a processing unit. The pixel sensor includes a photo detector and a storage capacitor. The photo detector is arranged for generating a first pixel signal. The storage capacitor is arranged for storing a second pixel signal. The processing unit is coupled to the pixel sensor, and arranged for generating an updated second pixel signal during a current operating cycle of the imaging processing circuit according to the first pixel signal and the second pixel signal. The updated second pixel signal is stored in the storage capacitor before a next operating cycle of the imaging processing circuit.

### BACKGROUND OF THE INVENTION

1. Field of the Invention

The present invention relates to an image sensor, and more particularly, to an imaging processing circuit capable of reducing shot noise.

2. Description of the Prior Art

In image sensor application, signal-to-noise ratio (SNR) is usually a good indicator for still image quality. In small pixel design, however, because fewer photons can actually hit a pixel sensor due to smaller pixel size, shot noise will become dominant and greatly affect the SNR.

Therefore, there is a need for an imaging processing circuit that can boost SNR by reducing the undesired effect caused by shot noise.

### SUMMARY OF THE INVENTION

In accordance with exemplary embodiments of the present invention, an imaging processing circuit capable of reducing shot noise is proposed to solve the above-mentioned problem.

According to an aspect of the present invention, an exemplary imaging processing circuit is disclosed. The exemplary imaging processing circuit includes at least a pixel sensor and a processing unit. The pixel sensor includes a photo detector and a storage capacitor. The photo detector is arranged for generating a first pixel signal. The storage capacitor is arranged for storing a second pixel signal. The processing unit is coupled to the pixel sensor, and arranged for generating an updated second pixel signal during a current operating cycle of the imaging processing circuit according to the first pixel signal and the second pixel signal. The updated second pixel signal is stored in the storage capacitor before a next operating cycle of the imaging processing circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an imaging processing circuit according to an embodiment of the present invention.

FIG. 2 is a timing diagram illustrating control signals of the imaging processing circuit shown in FIG. 1 according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

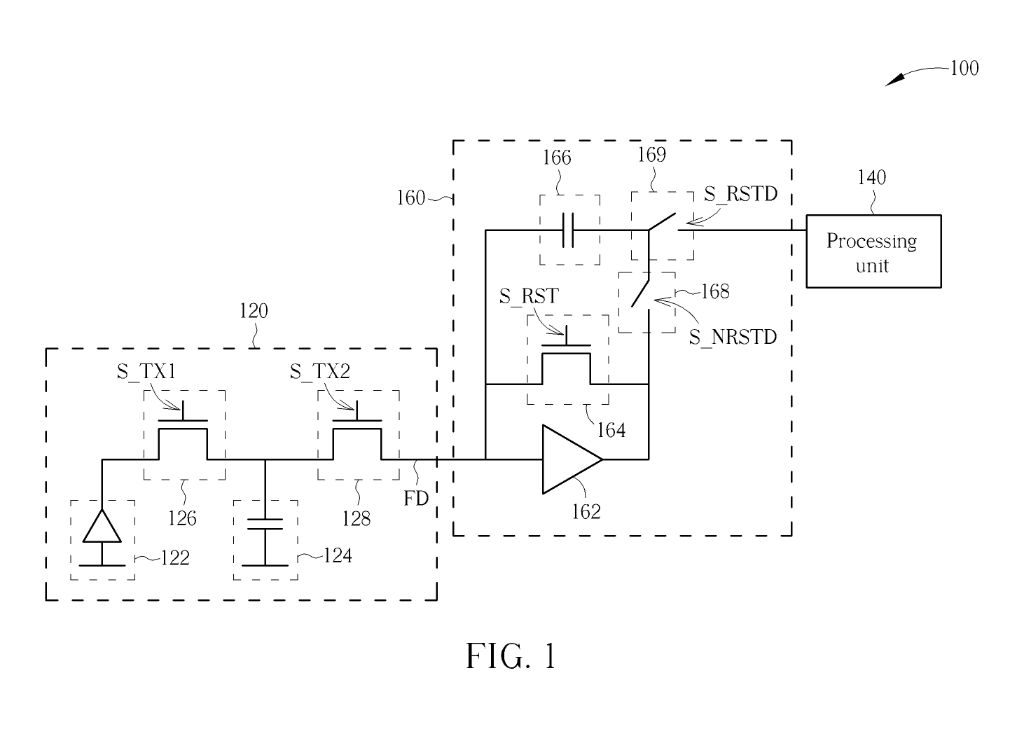

Please refer to FIG. 1, which is a schematic diagram illustrating an imaging processing circuit 100 according to an embodiment of the present invention. The imaging processing circuit 100 includes, but not limited to, at least a pixel sensor 120, a processing unit 140, and a readout circuit 160. For example, the pixel sensor 120 maybe an active pixel sensor, including, but not limited to, a photo detector 122, a storage capacitor 124, a first transfer gate 126, a second transfer gate 128 and a floating diffusion (FD) 129. The photo detector 122 is arranged for generating a first pixel signal S_P1. The first transfer gate 126 is coupled between the photo detector 122 and the storage capacitor 124, and arranged for transferring the first pixel signal S_P1 to the storage capacitor 124. The storage capacitor 124 is arranged for storing the first pixel signal S_P1 and a second pixel signal S_P2. The second transfer gate 128 is coupled between the storage capacitor 124 and the readout circuit 160, and arranged for transferring the first pixel signal S_P1 and the second pixel signal S_P2 to the readout circuit 160. The FD 129 is arranged for storing electrons, i.e. the first pixel signal S_P1 and the second pixel signal S_P2 before they are sent to the readout circuit 160. The processing unit 140 is coupled to the pixel sensor 120 and arranged for generating an updated second pixel signal S_P2′ during a current operating cycle of the imaging processing circuit 100 according to the first pixel signal S_P1 and the second pixel signal S_P2 read by the readout circuit 160. The updated second pixel S_P2′ signal is stored in the storage capacitor 124 before a next operating cycle of the imaging processing circuit 100.

The readout circuit 160 is coupled between the pixel sensor 120 and the processing unit 140, and includes, but is not limited to, a power amplifier 162, a reset gate 164, a capacitor 166, a first switch 168, and a second switch 169. The power amplifier 162 is arranged for outputting the first pixel signal S_P1 and the second pixel signal S_P2 to the processing unit 140. The reset gate 164 is arranged for resetting the power amplifier 162. The first switch 168 is arranged for selectively coupling the capacitor 166 and the reset gate 164. The second switch 169 is arranged for selectively coupling the capacitor 166 and the processing unit 140. Please note that, the storage capacitor 124 is utilized for storing the second pixel signal S_P2 from a previous operating cycle of the imaging processing circuit 100, i.e. the updated second pixel signal S_P2′ generated by the processing unit 140 during the previous operating cycle of the imaging processing circuit 100, however, this is for illustrative purposes only, and not meant to be a limitation of the present invention.

In this embodiment, during a current operating cycle of the imaging processing circuit 100, the readout circuit 160 first reads out the second pixel signal S_P2 stored in the storage capacitor 124 via the second transfer gate 128, and the power amplifier 162 outputs the second pixel signal S_P2 to the processing unit 140. Next, the photo detector 122 generates the first pixel signal S_P1 by converting a photonic signal into the first pixel signal S_P1. The first transfer gate 126 transfers the first pixel signal S_P1 from the photo detector 122 to the storage capacitor 124. The readout circuit 160 then reads out the first pixel signal S_P1 stored in the storage capacitor 124 via the second transfer gate 128, and the power amplifier 162 outputs the first pixel signal S_P1 to the processing unit 140. The processing unit 140 generates the updated second pixel signal S_P2′ by dividing the first pixel signal S_P1 with a predetermined mixed ratio M and combining a divided first pixel signal S_P1′ with the second pixel signal S_P2. The updated second pixel signal S_P2′ is written back to the storage capacitor 124 by the readout circuit 160. The updated second pixel signal S_P2′ stored in the storage capacitor 124 is then used as a second pixel signal S_P2 during the next operating cycle of the imaging processing circuit 100.

Please note that, the reset gate 164 should reset the power amplifier 162 before the first pixel signal S_P1 or the second pixel signal S_P2 is transferred via the first transfer gate 126 and the second transfer gate 128 during the current operating cycle of the imaging processing circuit 100. For example, the reset gate 164 may reset the power amplifier 162 before the second transfer gate 128 transfers the first pixel signal S_P1 and the second pixel signal S_P2 during the current operating cycle of the imaging processing circuit 100, or the reset gate 164 may reset the power amplifier 162 before the first transfer gate 126 and the second transfer gate 128 transfer the first pixel signal S_P1 during the current operating cycle of the imaging processing circuit 100. The reset gate 164 should also reset the power amplifier 162 before the readout circuit 160 writes back the updated second pixel signal S_P2′ to the storage capacitor 124. Please also note that, a magnitude of the updated second pixel signal S_P2′ stored in the storage capacitor 124 should be smaller than a magnitude of the updated second pixel signal S_P2′ generated by the processing unit 140 due to signal losses during signal transfer.

The abovementioned embodiment is presented merely for describing technical features of the present invention, and in no way should be considered as limiting of the scope of the present invention. People skilled in the art will readily appreciate that other designs for implementing the pixel sensor are feasible. For example, the imaging processing circuit 100 may include a pixel sensor array comprising a plurality of pixel sensors, and each of the pixel sensors has the same features possessed by the pixel sensor 120. In this alternative design, during the same operating cycle of the imaging processing circuit 100, all the first pixel signals S_P1 can collectively be viewed as a first frame data F1, all the second pixel signals S_P2 can collectively be viewed as a second frame data F2, and all the updated second pixel signals S_P2′ can collectively be viewed as an updated frame data F2′. In addition, the processing unit 140 generates the updated frame data F2′ by dividing the first frame data F1 with the mixed ratio M and combining a divided first frame data F1′ with the second frame data F2. In this way, the updated second frame data F2′ can be expressed as F2′=F2*G+F1/M. The restore ratio G is used to elaborate the effect of signal losses during signal transfer, and is therefore smaller than 1. Since the updated second frame data F2′ is later used as the second frame data F2 during the next operating cycle of the imaging processing circuit 100, this process continues, iteratively. As those skilled in the art should readily know, the resultant second frame data F2 should converge to a constant when the process goes on given that the restore ratio G is smaller than 1. In other words, the imaging processing circuit 100 can utilize this process to attenuate the shot noise and therefore acquire a boosted signal-to-noise ration (SNR).

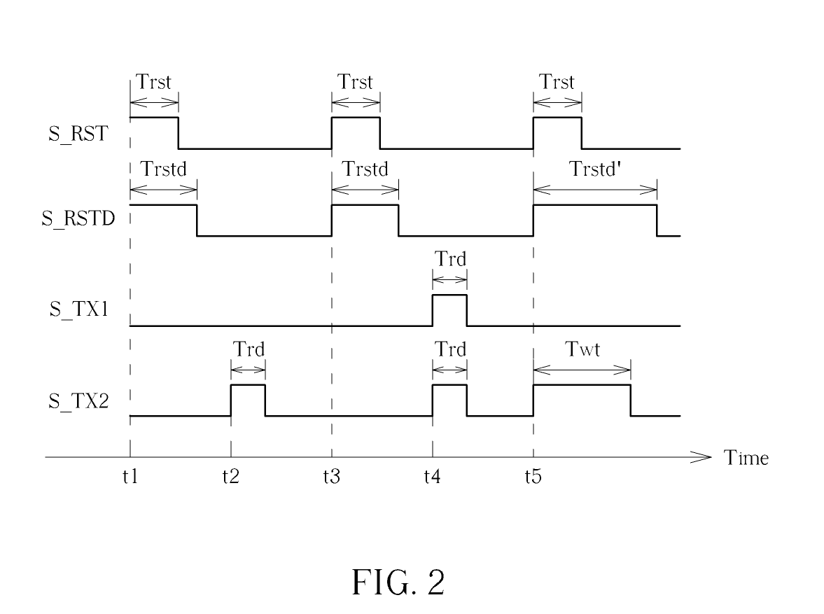

Please refer to FIG. 2, which illustrates a timing diagram of control signals of the imaging processing circuit 100 shown in FIG. 1 according to an embodiment of the present invention. As can be seen from FIG. 2, during an operating cycle of the imaging processing circuit 100, a reset control signal S_RST and a delayed reset control signal S_RSTD are asserted (turned on) at time t₁ to perform a reset operation on the power amplifier 162. The reset control signal S_RST is only asserted for a period of time Tᵣₛₜ while the delayed reset control signal S_RSTD is asserted for a longer period of time T_{rstd}. After the reset operation, a second transfer gate control signal S_TX2 is asserted for a period of time T_{rd} at time t₂ to perform a readout operation of the second pixel signal S_P2. After the readout operation of the second pixel signal S_P2, the reset control signal S_RST and the delayed reset control signal S_RSTD are asserted again at time t₃ to perform the reset operation on the power amplifier 162 again. The reset control signal S_RST is still asserted for the period of time Tᵣₛₜ while the delayed reset control signal S_RSTD is asserted for the period of time T_{rstd}. After the reset operation, the second transfer gate control signal S_TX2 and a first transfer gate control signal S_TX1 are both asserted for the period of time T_{rd} at time t₄ to perform a readout operation of the first pixel signal S_P1. After the readout operation of the first pixel signal S_P1, the reset control signal S_RST and the delayed reset control signal S_RSTD are asserted again at time t₅ to perform the reset operation on the power amplifier 162 again. The reset control signal S_RST is still asserted for the period of time Tᵣₛₜ while the delayed reset control signal S_RSTD is asserted for a period of time T_{rstd′}. The second transfer gate control signal S_TX2 is also asserted at time t₅ to perform a restore operation of the updated second pixel signal S_P2′. The second transfer gate control signal S_TX2 is asserted for a period of time T_{wt}, where the time period T_{rstd′} is longer than the time period T_{wt} . Please not that, the first switch 168 is controlled by an inverting delayed reset control signal S_NRSTD which is an inverting signal of the delayed reset control signal S_RSTD. Those skilled in the art should readily understand operations of the delayed reset control signal S_RSTD after reading the above paragraph; therefore a detailed descriptions is omitted for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging processing circuit, comprising:
at least a pixel sensor, comprising:
a photo detector, for generating a first pixel signal;
a storage capacitor, for storing a second pixel signal;
a first transfer gate, coupled between the photo detector and the storage capacitor, for transferring the first pixel signal;
a second transfer gate, coupled between the storage capacitor and the readout circuit, for transferring the first pixel signal and the second pixel signal; and
a floating diffusion, for storing electrons; and
a processing unit, coupled to the pixel sensor, for generating an updated second pixel signal during a current operating cycle of the imaging processing circuit according to the first pixel signal and the second pixel signal, wherein the updated second pixel signal is stored in the storage capacitor before a next operating cycle of the imaging processing circuit.

2. The imaging processing circuit of claim 1, wherein the processing unit generates the updated second pixel signal by dividing the first pixel signal with a predetermined factor and combining a divided first pixel signal with the second pixel signal.

3. The imaging processing circuit of claim 1, wherein a magnitude of the stored updated second pixel signal is smaller than a magnitude of the generated updated second pixel signal.

4. The imaging processing circuit of claim 1, further comprising:
a readout circuit, coupled between the pixel sensor and the processing unit, comprising:
a power amplifier, for outputting the first pixel signal and the second pixel signal to the processing unit; and
a reset gate, for resetting the power amplifier.

5. The imaging processing circuit of claim 4, wherein the pixel sensor and the readout circuit form an active pixel sensor.

6. The imaging processing circuit of claim 4, wherein the readout circuit is further arranged for writing back the updated second pixel signal to the storage capacitor.

7. The imaging processing circuit of claim 6, wherein the reset gate resets the power amplifier before the readout circuit writes back the updated second pixel signal to the storage capacitor.

8. The imaging processing circuit of claim 4, wherein the reset gate resets the power amplifier before the second transfer gate transfers the first pixel signal and the second pixel signal during the current operating cycle of the imaging processing circuit.

9. The imaging processing circuit of claim 4, wherein the reset gate resets the power amplifier before the first transfer gate and the second transfer gate transfer the first pixel signal during the current operating cycle of the imaging processing circuit.
